(19) United States
(12) Patent Application Publication
(10) Pub. No.: US 2023/0194038 A1
(43) Pub. Date: Jun. 22, 2023

(54) STRENGTH MEMBER FOR PIPE REINFORCEMENT

(71) Applicant: J. & P. COATS, LIMITED, Uxbridge (GB)

(72) Inventors: Alican Celteklioglu, Uxbridge (GB); Gokhan K. Coban, Uxbridge (GB); Pradipkumar Bahukudumbi, Uxbridge (GB); Andreu Laborda, Uxbridge (GB)

(73) Assignee: J. & P. COATS, LIMITED, Uxbridge (GB)

(21) Appl. No.: 17/803,837

(22) Filed: Dec. 16, 2022

Related U.S. Application Data
(60) Provisional application No. 63/290,204, filed on Dec. 16, 2021.

(51) Int. Cl. F16L 58/10; F16L 9/04; B05D 1/18

(52) U.S. Cl. CPC F16L 58/1063; B05D 1/18; F16L 9/042; B05D 2256/00

(57) ABSTRACT

A coated tow includes a fiber bundle composed of continuous reinforcement fibers that form a flat substrate in a ribbon shape and a thermoplastic-based overcoating applied to the flat substrate to form a uni-directional tape. An extruded tape includes a plurality of cords of twisted fiber yarns each composed of continuous reinforcement fibers, a thermoplastic overcoating applied to each of the cords, and a high density polyethylene (HDPE) that encases the plurality of cords to form a uni-directional tape. The reinforcement fibers have continuous filaments aligned lengthwise along a length each of the cords. A process of producing the coated tow or extruded tape includes feeding one or more spools of continuous fiber tow under tension control, sinking the continuous fiber tow in a chemical bath, passing the wetted continuous fiber tow through one or more squeezing rollers, and passing the continuous fiber tow through an oven.

### RELATED APPLICATIONS

This application claims priority benefit of U.S. Provisional Application Serial No. 63/290,204 filed 16 Dec. 2021; the contents of which are hereby incorporated by reference.

### FIELD OF THE INVENTION

The present invention in general relates to fiber reinforced composites and in particular to fiber-based strength members for reinforcement of pipes and vessels subjected to high pressure and adverse conditions, and a method of construction thereof.

### BACKGROUND OF THE INVENTION

The continuing demand for oil and natural gas has increased the need to develop new off-shore oil and gas deposits. Off-shore drilling platforms are now routinely positioned further from land, and mine oil and gas deposits from beneath ocean floors that are several orders of magnitude deeper than just a few decades ago. Materials used in the oil and gas industry must be able to withstand high pressure and resist the corrosive effects of the environment and the chemicals that contact the materials. Traditional materials such as steel are proving to be inadequate to meet the increasing physical demands of off-shore drilling, as well as other industrial applications, and that has led to the use of composite materials to augment steel and other traditional materials.

Composite materials are materials made from two or more constituent materials with significantly different physical or chemical properties that when combined afford characteristics different from the individual components. The individual components remain separate and distinct within the finished structure. A composite material may be preferred for many reasons: common examples include materials which are stronger, lighter, and more durable and corrosion resistant when compared to traditional materials.

Composite materials are formed from two or more constituent materials with significantly different physical or chemical properties that remain separate and distinct in the finished structure. There are two categories of constituent materials: matrix and reinforcement. At least one portion of each type is required. The matrix material surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

Commercially produced composites often use a polymer matrix material that is either a thermoplastic or thermoset resin. There are many different polymers available depending upon the starting raw ingredients which may be placed into several broad categories, each with numerous variations. Examples of the most common categories for categorizing polymers include polyester, vinyl ester, epoxy, phenolic, polyimide, polyamide, polypropylene, PEEK, and others.

Fiber-reinforced composite materials can be divided into two main categories normally referred to as short fiber-reinforced materials and continuous fiber-reinforced materials. Continuous reinforced materials often constitute a layered or laminated structure. The woven and continuous fiber styles are typically available in a variety of forms, being pre-impregnated with the given matrix (resin), dry, uni-directional tapes of various widths, plain weave, harness satins, braided, and stitched. Various methods have been developed to reduce the resin content of the composite material, by increasing the fiber content. Typically, composite materials may have a ratio that ranges from 60% resin and 40% fiber to a composite with 40% resin and 60% fiber content. The strength of a product formed with composites is greatly dependent on the ratio of resin to reinforcement material.

Thus, with the increasing demands of the oil and gas industry and other industries that employ the use of pipes and other implements and tools that are subjected to high pressures, corrosive substances, and other adverse conditions there exists a need for improved reinforcement members for these pipes and other implements and tools.

### SUMMARY OF THE IVNENTION

The present invention provides a coated tow that includes a fiber bundle composed of continuous reinforcement fibers that form a flat substrate in a ribbon shape and a thermoplastic-based overcoating applied to the flat substrate to form a uni-directional tape. The reinforcement fibers have continuous filaments aligned lengthwise along a length of the flat substrate.

The present invention additionally provides an extruded tape that includes a plurality of cords of twisted fiber yarns each composed of continuous reinforcement fibers, a thermoplastic overcoating applied to each of the cords, and a high density polyethylene (HDPE) that encases the plurality of cords to form a uni-directional tape. The reinforcement fibers have continuous filaments aligned lengthwise along a length each of the cords.

The present invention additionally provides a process of producing the coated tow or extruded tape that includes feeding one or more spools of continuous fiber tow under tension control to provide stability and prevent transverse movement of the fiber tow, sinking the continuous fiber tow in a chemical bath that holds the thermoplastic-based coating to wet the continuous fiber tow, passing the wetted continuous fiber tow through one or more squeezing rollers to remove excessive coating and to shape the cross sectional shape of the continuous fiber tow, and passing the continuous fiber tow through an oven to dry and fix the coating to the continuous fiber tow.

The coated tow or extruded tape being useful for spiral winding around a steel or composite tube used in gas and oil exploration.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flat bundle coated with an embodiment of the inventive formulation to form a coated tow on a spool;

FIG. 2 illustrates a twisted fiber yarn coiled on a spool, where the twisted fiber yarn is coated with embodiments of the inventive formulation;

FIGS. 3A-3C are a series of views that illustrate an extruded tape with a plurality of coated fiber cords of the twisted fiber yarn of FIG. 2 encased in polyethylene (PE) in accordance with embodiments of the invention;

FIG. 3D illustrates the coated tow of FIG. 1 being wrapped around the outer perimeter of a pipe;

FIG. 3E illustrates the extruded tape of FIGS. 3A-3C being wrapped around the outer perimeter of a pipe;

FIG. 4 is a bar graph that illustrates the results of comparative examples 1-7 for changes of tensile strength versus temperature at 25° C. and at 95° C. of a series of flat coated tow with various formulations in accordance with embodiments of the invention;

FIGS. 5A and 5B show the test set up and samples used for comparative examples 8-15 to test for adhesion of twisted fiber yarn that was coated with embodiments of the inventive formulation to PE; and

FIG. 6 is a bar graph that illustrates the adhesion test results of comparative examples 8-15.

### DESCRIPTION OF THE INVENTION

The present invention has utility as a reinforcement member for use in the construction or repair of high-pressure pipe and vessel structures. Embodiments of the inventive reinforcement member in the form of a flat coated fiber tow or as an extruded tape exhibit improved tensile strength, thermal stability of mechanical properties, cycling and fatigue performance, resistance to moisture, or a combination thereof. Embodiments of coated twisted fiber tow used in an extruded tape exhibit improved adhesion to a polymeric matrix that encase the cords of coated twisted fiber tow. Embodiments of the invention provide the aforementioned strength characteristics by enabling the pure tensile properties of continues fibers. Therefore, very high level of fiber content become available with flexibility in cross section while maintaining the tensile modulus. These characteristics allow a wider range of winding angle for pipes or vessel structures, whether the fibers are used as flat ribbons of coated tow or twisted cords. A non-limiting application of inventive embodiments is as a strengthening member for high pressure pipes and vessels used in the oil and gas industry that provide a sufficient level of protection against high internal constant and variable pressure under different environmental conditions. Environmental conditions refer to the application conditions in a specific location such as temperature level extremes (high - low), moisture, and direct contact to fresh water or ocean salt water.

Embodiments of the inventive reinforcement members employ the use of continuous fibers which are required to be located over and/or around the application pipes. The continuous fibers illustratively include glass, carbon, or aramid but are not limited to these types and may further include other synthetic polymeric or natural fibers. It is noted that the use of virgin reinforcement fibers into the pipe structure results in a fiber filamentation and tensile strength drop in high temperature applications, and also provides an improvement in long-term burst and cycling/fatigue performance.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, any reference to weight percent or by extension molecular weight of a polymer is based on weight average molecular weight.

In a specific embodiment of the inventive reinforcement member, a thermoplastic-based coating is applied to a continuous fiber substrate, which may be extruded with a polymeric matrix. Possible continuous fibers illustratively include but are not limited to carbon fiber, glass fiber, basalt fiber, aramid fiber, polyester, polyamide, or combinations thereof.

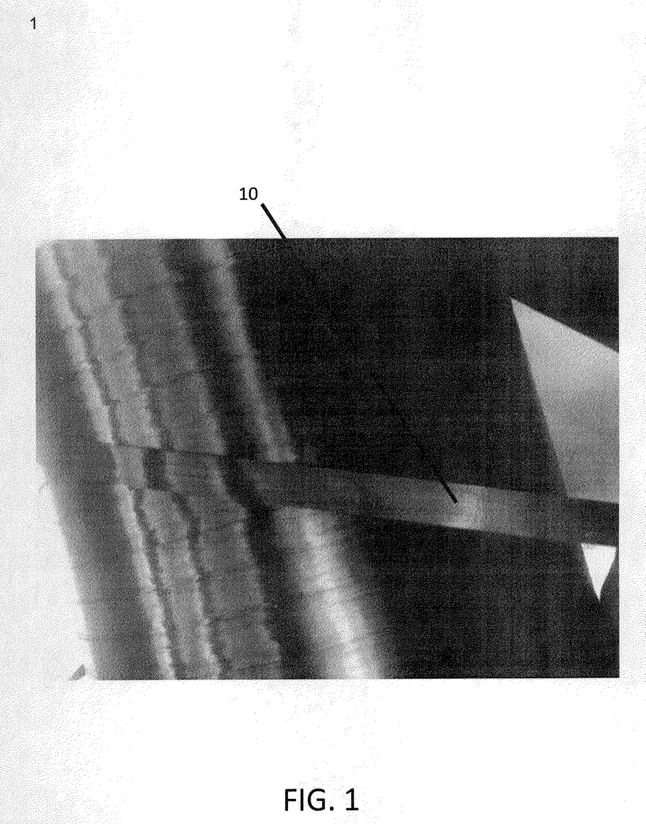

FIG. 1 illustrates a flat coated tow with an embodiment of the inventive formulation that is in the form of a ribbon 10 coiled on a spool. As will be explained further below and in the comparative examples 1-7, the continuous fibers or filaments are in the flat coated tow that forms the ribbon 10. The thickness to width ratio of the ribbon 10 may be varied based on the intended use. The individual filaments that make up the bundle that form the ribbon 10 are aligned along the length of the ribbon 10 and the filaments are not twisted. It is appreciated that the length of the continuous fiber depends on the raw material filaments that form the fiber.

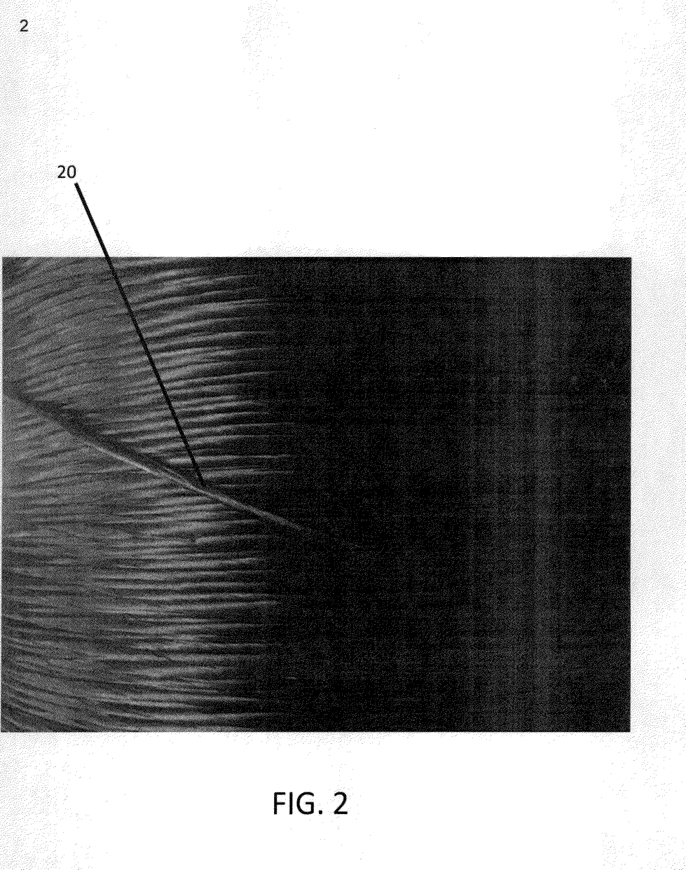

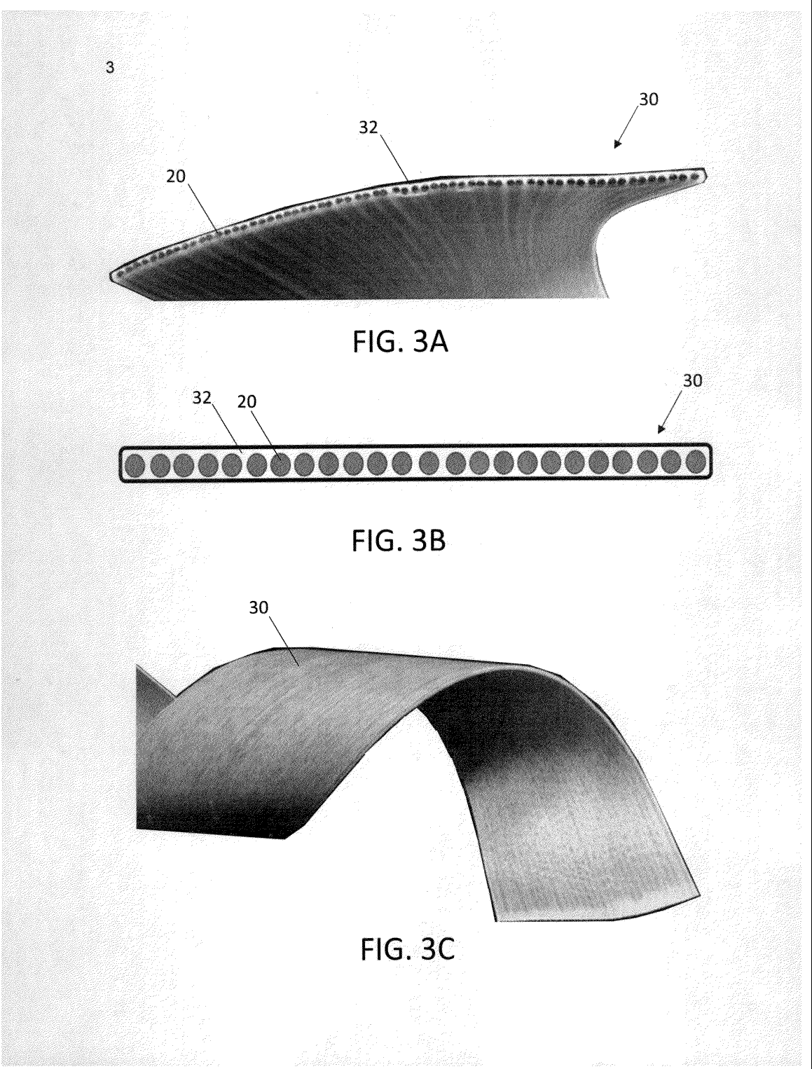

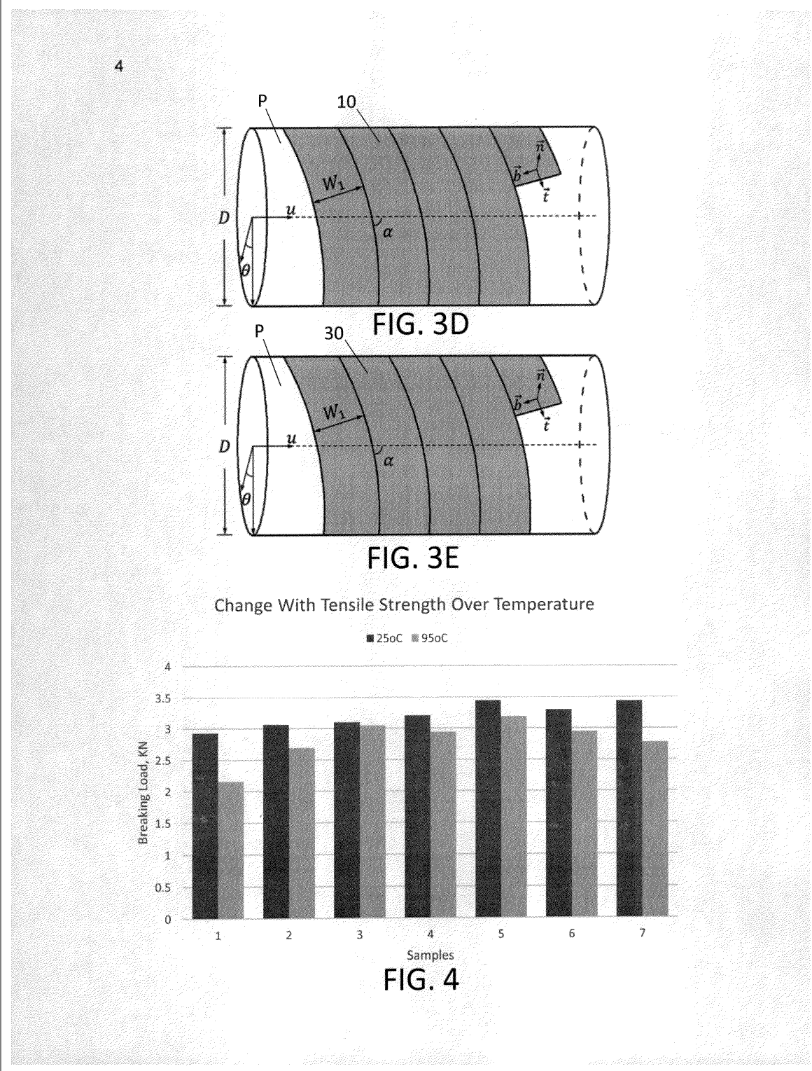

FIG. 2 illustrates a twisted fiber yarn 20 coiled on a spool. The twisted fiber yarn 20 is coated with embodiments of the inventive formulation. As will be explained further below and in the comparative examples 8-15 the coated twisted fiber yarn 20 exhibits improved adhesion to non-limiting examples of encasing materials illustratively including polyethylene, high density polyethylene (HDPE), polypropylene, polyamide, thermoplastic polyurethane (TPU), and polyvinyliden fluoride (PVDF), amongst others. In specific inventive embodiments coated twisted fiber cords 20 are encased in extruded tapes. FIG. 3A illustrates an extruded tape 30 with a plurality of coated fiber cords 20 encased in polyethylene (PE) 32. FIG. 3B is a cross sectional view of FIG. 3A that more clearly illustrates the cords 20 of twisted coated fibers encased in the PE 32 of the extruded tape 30. FIG. 3C is a perspective view of the extruded tape 30. FIG. 3D illustrates the flat tow ribbon 10 being wrapped around an outer perimeter of a pipe P. FIG. 3E illustrates the extruded tape 30 being wrapped around an outer perimeter of a pipe P. Extruded tapes may be made in varying thicknesses and widths, with a variable amount of cords, and in a geometry that is rectangular or orbital. Embodiments of the extruded tapes as well as the flat coated fiber tow may be used in flexible pipes, reinforced thermoplastic pipes, and buoyancy clamping.

In some inventive embodiments, the flat coated fiber tow or the extruded tape may serve as a high tensile strength composite reinforcement that is corrosion resistant and functions as a light-weight metal replacement. Composite reinforcements provide excellent mechanical performance and flexibility. Embodiments of the inventive flat coated fiber tow or the extruded tape may be used in the initial manufacture of pipes and as a pipe wrap for the repair of pipes. In a further non-limiting application electrical cables or umbilicals may utilize embodiments of the inventive flat coated fiber tow or the extruded tape for their lightweight and high tensile strength.

In some inventive implementations of flat carbon fiber tow with a thermoplastic-based coating formulation, a tenacity of between 1.66 and 2.00 Newtons/tex (N/Tex) is noted, while the tensile strength of a conventional virgin carbon fiber tow is between 1.3 and 1.5 Newtons/tex (N/Tex) according to applied bundle strength test based on ASTM D885. In implementations of the inventive thermoplastic-based coating applied to two ends assembled and twisted yarns, the twisted yarns exhibited a tensile strength between 1.45 and 1.65 Newtons/tex (N/Tex) that also exceeds that of the conventional materials.

A specific embodiment of the inventive thermoplastic coating composition is based on a polyurethane-based thermoplastic material as its main component. Table 1 summarizes a non-limiting example of the components that may be used in formulations of the inventive coating.

TABLE 1

Formulation components of the thermoplastic coating
Formulation of the coating composition

| | |
|---|---|
| Component | Range of component in composition (wt. %) |
| Curable polymeric dispersion | > 40-Remainder |
| Cross-linker | 1-25 |
| Wetting agent | 0.1-10 |
| Water | 0-40 |
| Adhesion promoter | 5-60 |
| Optional additives | Each at 0-5 |

The use of a curable polymeric dispersion with high glass transition temperature (Tg) of from -40 to 60° C. and/or high solids content (≥40%), enables a coated carbon fiver tow to better maintain its mechanical properties at higher temperatures, as opposed to conventional reinforcement members. A polymeric dispersion operative herein illustratively includes polyesters, vinyl acetate, polyacrylate, epoxy resins, polyimides, polyester resins, silicones, and combinations thereof.

This thermal stability may be also achieved and/or further increased by the use of cross-linkers. A typical composition used in inventive embodiments includes a cross-linker that reacts with nucleophilic moieties present in the aqueous polymeric dispersion. Conventional cross-linkers for aqueous polymer dispersions include conventional isocyanates, aziridines, melamines, polycarbodiimides, and combinations thereof.

Adhesion promoters may also be used to increase the coating adhesion to subsequent polymer compounds illustratively including but not limited to acrylic acid, silanes, cyanoacrylates, polysilicic acid, chlorinated polyolefin, ethylene copolymer of ethylene and acrylates, organosilane, organotitanate, zirconate, zircoaluminate, alkyl phosphate ester, metal organics, and combinations thereof.

It is further noted that various optional components may also advantageously be employed in embodiments of the coating composition of this invention. Illustrative examples of additives may include antioxidants, ultraviolet (UV) stabilizers, colorants, coupling agents, flame retardants, anti-static agents, plasticizers, fillers, or any combination thereof.

Filler particles operative in the inventive coating illustratively include glass microspheres that are solid or hollow; calcium carbonate, calcium silicate, alumina, ATH, talcs, dolomite, vermiculite, diatomaceous earth, kaolin clay, graphite, metal, silica particles; inorganic carbonates; and combinations thereof. Factors relevant in the choice of a particulate filler illustratively include filler cost, resultant viscosity of flow properties, resultant shrinkage, surface finish weight, flammability, electrical conductivity, and chemical resistance of the thermoset formulation. Particulate filler typically accounts from 0 to 5 weight percent of the molding composition total weight. Typical filler sizes are from 0.1 to 50 microns.

The diameters of lengthwise overcoated fibers are appreciated to vary widely based on commercial sources with glass filler fibers having typical diameters of 0.03 to 0.5 millimeters (mm); carbon filler fibers having typical diameters of 0.005 to 0.1 mm; and natural filler fibers having typical diameters of 0.01 to 0.3 mm. It should be appreciated that fiber dimensions outside of the aforementioned typical ranges exist and are intended to be within the scope of the present invention.

A particular embodiment of a production method for producing embodiments of the coated fiber reinforcement members may be based on a modified deep impregnation coating process in which various coating formulations are applied to the fibers based on improving specific desired properties or performance parameters. Production starts with a virgin uni-directional bundle in the form of one or more spools of continuous fiber tow fed with tension control. Single or multiple ends of fiber tow may be fed simultaneously or separately. The feeding path should be suitable to avoid transverse movement of the fibers during the operation. Once the fibers obtain stability pursuant to transverse movement, the continuous fibers are sunk deep inside a chemical bath that holds the formulation to be deposited on the continuous fibers. The travel distance in the chemical bath provides the desired level of wetting to the continuous fiber tow. After the chemical bath, wetted continuous fiber tow bundle goes through one or more squeezing rollers to remove excessive chemicals. During the squeezing stage, a cross sectional shape of the profile of the continuous fibers may be set with dies, the dies being round and/or any specific shape such as square or rectangular. The next step of the operation is drying and fixing of the coating chemicals to the continuous fibers in an oven. The total travel time and length of dwell time in the oven is the function of following primary parameters, but not limited only to these parameters; oven set temperature, line speed, squeezing roller pressure, chemical type including concentration and formulation. Subsequently, dried bundles can be directly wound, or the bundles can be twisted for an increase of bundle flexibility and elongation properties; to provide a more compact product. Whether the twisting operation is required or not is determined pursuant to the end use application.

A pipe for oil and gas exploration or transport is provided that includes a conventional tube formed of steel or a composite material with an inventive uni-directional tape spiral wound therearound formed as the flat coated tow or as the extruded tape as both described herein.

The present invention is further detailed with respect to the following examples that are not intended to limit the scope of the claimed invention, but rather to illustrate specific aspects of the invention.

### EXAMPLES

### Examples 1-7: Flat Bundle Targeting Improved Thermally Stable Tensile Strength

Table 2 provides a summary of the coating formulations applied to a flat 24 K carbon fiber bundle an example of which is shown in FIG. 1 as UD tape ribbon 10.

TABLE 2

Coating Formulations of Examples 1-7

| Component | Example 1 (wt. %) | Example 2 (wt. %) | Example 3 (wt. %) | Example 4 (wt. %) | Example 5 (wt. %) | Example 6 (wt. %) | Example 7 (wt. %) |
|---|---|---|---|---|---|---|---|
| Anionic/non-ionic polyester urethane polymer dispersion, ~40 wt. % solids pH ~ 7.5 | 50 | 80 | 0 | 0 | 0 | 0 | 0 |
| Ethylene acrylic acid -adhesion promotor, solid content 16.5%-17.5%, pH 11-12 | 50 | 0 | 0 | 0 | 0 | 0 | 0 |
| Anionic/non-ionic polyester urethane polymer dispersion, ~55 wt. % solids, pH ~ 7.7 | 0 | 0 | 0 | 0 | 0 | 20 | 0 |
| Dispersion of an oxime-blocked isocyanate, cationic/nonionic, pH ~3.5 - Cross-linker | 0 | 20 | 0 | 20 | 0 | 0 | 20 |
| Anionic/non-ionic polyester urethane polymer dispersion, -50 wt. % solids pH -7 | 0 | 0 | 0 | 0 | 100 | 80 | 80 |
| Anionic Polyurethane dispersion, ~40 wt. % solids, pH ~8 | 0 | 0 | 100 | 80 | 0 | 0 | 0 |

### Example 1

An embodiment of the inventive coating was applied to a 24 K carbon fiber bundle with 7 micron diameter fibers, tensile strength of 4,900 MPa, and a linear density of 1650 tex are coated by the aforementioned impregnation process. The coating composition included a polyester polyurethane having 40% solid content and Tg of -40° C., also an ethylene acrylic acid is included. After the coating composition was applied, the resultant uni-directional flat coated fiber tow contained approximately 11% (wt.) of coating.

The coated carbon fiber exhibited a tensile strength of 2.95 kN at room temperature, which decreased as temperature increased as shown in Table 3.

### Example 2

Using the same process, the same 24 K carbon fiber bundle substrate and base coating formulation of Example 1, however a cross-linker agent was added to the formulation as well as the elimination of ethylene acrylic acid. The cross-linker used in this example was an oxime-blocked polyisocyanate dispersion detailed above in Table 2. After the coating composition was applied, the resultant uni-directional flat coated fiber tow contained approximately 11% (wt.) of coating.

The coated carbon fiber exhibited a tensile strength of 3 kN at room temperature, which decreased as temperature increased as shown in Table 3.

### Example 3

The same process and substrate used in Example 2, however, the type and amount of polyurethane were modified. The polyurethane dispersion used in this example was a polyester polyurethane by having 40% solid content and Tg of -20° C. After the coating composition was applied, the resultant uni-directional flat coated fiber tow contained approximately 13% (wt.) of coating.

The coated carbon fiber exhibited a tensile strength of 3.1 kN at room temperature and changed with increased temperature as shown in Table 3.

### Example 4

The same process, substrate and base coating medium used in Example 3 was used in Example 4, however, a cross-linker agent was added to the formulation. The cross-linker used in this example was an oxime-blocked polyisocyanate dispersion as detailed in Table 2. After the coating composition was applied, the resultant uni-directional flat coated fiber tow contained approximately 13% (wt.) of coating.

The coated carbon fiber exhibited a tensile strength of 3.2 kN at room temperature and changed with increased temperature as shown in Table 3.

### Example 5

The same process and substrate used in Example 4 was used on Example 5, however, the type and amount of polyurethane was modified as well as the elimination of crosslinker usage. The polyurethane dispersion used in this example was a polyester polyurethane having 50% solid content and Tg of -40° C. After the coating composition was applied, the resultant uni-directional flat coated fiber tow contained approximately 14% (wt.) of coating.

The coated carbon fiber exhibited a tensile strength of 3.45 kN at room temperature and changed with increased temperature as shown in Table 3.

### Example 6

The same process, substrate, and base coating medium used in Example 5 was used on Example 6, however, another polyurethane dispersion was added to the composition. The polyurethane dispersion used as an addition in this example was a polyester polyurethane having 54% solid content and Tg of 41° C., with adhesion promoter attributions. After the coating composition was applied, the resultant uni-directional flat coated fiber tow contained approximately 15% (wt.) of coating.

The coated carbon fiber exhibited a tensile strength of 3.3 kN at room temperature and changed with increased temperature as shown in Table 3.

### Example 7

The same process, substrate and base coating medium used in Example 6, however, instead of using an additional polyurethane dispersion; a cross-linker agent was added to the formulation. The cross-linker used in this example was the above-detailed oxime-blocked polyisocyanate dispersion. After the coating composition was applied, the resultant uni-directional flat coated fiber tow contained approximately 15% (wt.) of coating.

The coated carbon fiber exhibited a tensile strength of 3.4 kN at room temperature and changed with increased temperature as shown in Table 3.

The results of the reinforcement members in the form of a coated flat bundle or ribbon as tested in Examples 1 to 7 are shown below in Table 3. FIG. 4 is a bar graph that illustrates the results of Examples 1-7 for the change of tensile strength versus temperature at 25° C. and at 95° C.

TABLE 3

Change with breaking load over temperature

| Example | Tensile strength @ 25° C. (kN) | Tensile Strength @ 95° C. (%) | Change in Tensile properties @ 95° C., (%) |
|---|---|---|---|
| Example 1 | 2.95 | 2.16 | -27 |
| Example 2 | 3.00 | 2.69 | -11 |
| Example 3 | 3.10 | 3.05 | -18 |
| Example 4 | 3.20 | 2.94 | -8 |
| Example 5 | 3.45 | 3.18 | -7 |
| Example 6 | 3.30 | 2.94 | -10 |
| Example 7 | 3.40 | 2.78 | -19 |

### Examples 8-15: Coated Twisted Yarn Targeting Improved Adhesion Properties

Examples 8-15 demonstrate that the coated twisted fiber yarn 20 exhibits improved adhesion to high density polyethylene (HDPE). As previously shown in FIG. 3A, in specific inventive embodiments coated twisted fiber cords 20 are encased in extruded tape 30 formed of HDPE.

The adhesion test set up for assessing adhesion between carbon fiber and high density polyethylene for comparative examples 8-15 is via fiber pull-out type of test, based on ASTM D4776-02. The samples were manufactured in an in-house built pneumatic press-mold able to reach up to 240° C.

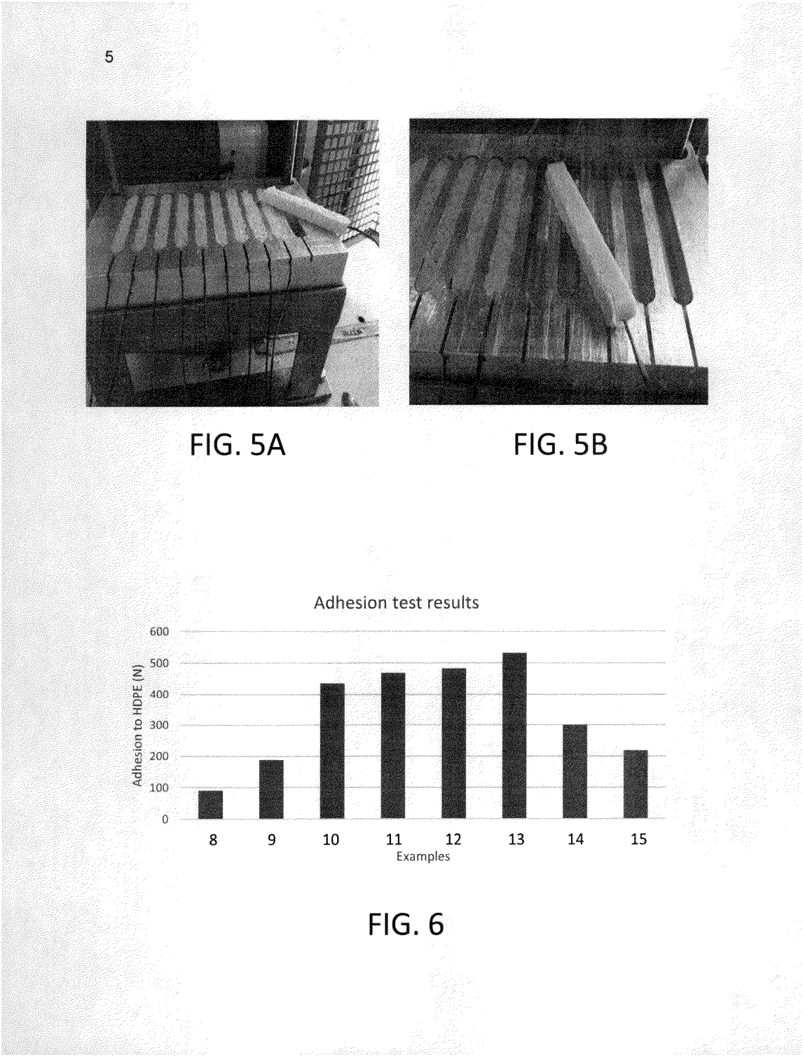

Prepared samples were placed in a dynamometer, where the HDPE was subjected to a bottom clamp and the carbon fiber to a top clamp. The amount of adhesion was then defined as the maximum force applied by the dynamometer to separate the carbon fiber from the HDPE. FIGS. 5A and 5B show the test set up and samples.

Table 4 provides a summary of the coating formulations applied to a 48 K carbon fiber bundle an example of which is shown in FIG. 2.

TABLE 4

The coating compositions applied to the 48 K carbon fiber bundle for Examples 8-15.
Composition of examples

| Component | Example 8 (wt. %) | Example 9 (wt. %) | Example 10 (wt. %) | Example 11 (wt. %) | Example 12 (wt. %) | Example 13 (wt. %) | Example 14 (wt. %) | Example 15 (wt. %) |
|---|---|---|---|---|---|---|---|---|
| Polyurethane solution sizing anionic/nonionic polyurethane dispersion, ~30 wt.% solids, pH: 6.5-10.5 | 100 | 0 | 0 | 0 | 0 | 0 | 0 | 0 |
| Anionic/nonionic polyester urethane polymer dispersion, ~50 wt. % solids pH -7.5 | 0 | 100 | 75 | 50 | 75 | 50 | 50 | 90 |
| Ethylene acrylic acid -adhesion promotor | 0 | 0 | 25 | 50 | 0 | 0 | 0 | 0 |
| Ethylene acrylic acid-adhesion promoter | 0 | 0 | 0 | 0 | 25 | 50 | 0 | 0 |
| High density polyethylene emulsion-adhesion promoter | 0 | 0 | 0 | 0 | 0 | 0 | 50 | 0 |
| Trimethoxysilane | 0 | 0 | 0 | 0 | 0 | 0 | 0 | 10 |

### Example 8

In this example, the coating was applied to a 48 K twisted carbon fiber yarn with similar properties to that detailed in Example 1 and having a linear density of 3648 tex and coated by the aforementioned impregnation process. The coating composition included a polyurethane-based sizing solution detailed in Table 4.

The coated carbon fiber exhibited an adhesion to HDPE of 90 N.

### Example 9

The same process and substrate used in Example 8 was used in Example 9, however, the type and amount of polyurethane were modified. The polyurethane dispersion used in this example was a polyester polyurethane having 40% solid content and Tg of -40° C.

The coated carbon fiber exhibited an adhesion to HDPE of 187 N.

### Example 10

The same process and substrate used in Example 9 was used in Example 10, however, an ethylene acrylic acid dispersion was added to the coating formulation.

The coated carbon fiber exhibited an adhesion to HDPE of 435 N.

### Example 11

The same process and substrate used in Example 10 was used in Example 11, however, the amount of ethylene acrylic acid dispersion was increased.

The coated carbon fiber exhibited an adhesion to HDPE of 468 N.

### Example 12

The same process and substrate used in Example 11 was used in Example 12, however, the ethylene acrylic acid dispersion was replaced by a modified ethylene acrylic acid dispersion.

The coated carbon fiber exhibited an adhesion to HDPE of 482 N.

### Example 13

The same process and substrate used in Example 12 was used in Example 13, however, the amount of ethylene acrylic acid dispersion was increased as noted in Table 4.

The coated carbon fiber exhibited an adhesion to HDPE of 531 N.

### Example 14

The same process and substrate used in Example 13 was used in Example 14, however, the ethylene acrylic acid dispersion was replaced by high density polyethylene emulsion as an adhesion promoter.

The coated carbon fiber exhibited an adhesion to HDPE of 300 N.

### Example 15

The same process and substrate used in Example 14 was used in Example 15, however, an epoxy functional silane was added into the mixture by replacing the ethylene acrylic acid.

The coated carbon fiber exhibited an adhesion to HDPE of 218 N.

Table 5 summarizes the results of the adhesion of the coated 48 K twisted bundles to HDPE of examples 8-15. FIG. 6 is a bar graph that illustrates the results of Examples 8-15.

TABLE 5

Adhesion test results
%wt. of coating and tensile strength at different temperatures of examples

| Example | Adhesion to HDPE (N) |
|---|---|
| Example 8 | 90 |
| Example 9 | 187 |
| Example 10 | 435 |
| Example 11 | 468 |
| Example 12 | 482 |
| Example 13 | 531 |
| Example 14 | 300 |
| Example 15 | 218 |

The foregoing description is illustrative of particular embodiments of the invention, but is not meant to be a limitation upon the practice thereof. The following claims, including all equivalents thereof, are intended to define the scope of the invention.

1. A coated tow comprising:
a fiber bundle composed of continuous reinforcement fibers that form a flat substrate in a ribbon shape, said reinforcement fiber having continuous filaments aligned lengthwise along a length of the flat substrate;
a thermoplastic-based overcoating applied to said flat substrate to form a uni-directional tape.

2. The coated tow of claim 1 wherein said continuous fibers comprise carbon fiber, glass fiber, basalt fiber, aramid fiber, or a combination thereof.

3. The coated tow of claim 1 wherein said thermoplastic overcoating comprises an aqueous polymeric dispersion.

4. The coated tow of claim 1 further comprising at least one of a wetting agent, and an adhesion promoter.

5. The coated tow of claim 1 wherein said thermoplastic overcoating is derived from an aqueous dispersion.

6. The coated tow of claim 1 wherein said thermoplastic overcoating further comprises at least one of antioxidants, ultraviolet (UV) stabilizers, plasticizers, or fillers.

7. The coated tow of claim 1 wherein said thermoplastic overcoating further comprises a cross-linker.

8. The coated tow of claim 1 wherein said thermoplastic overcoating further comprises a fiber sizing composition components.

9. An extruded tape comprising:
a plurality of cords of twisted fiber yarns each composed of continuous reinforcement fibers, said reinforcement fibers having continuous filaments aligned lengthwise along a length each of the cords;
a thermoplastic overcoating applied to each of said cords; and
a high density polyethylene (HDPE) that encases the plurality of cords to form the uni-directional tape.

10. The extruded tape of claim 9 wherein said continuous fibers comprise carbon fiber, glass fiber, basalt fiber, aramid fiber, or a combination thereof.

11. The extruded tape of claim 9 wherein said thermoplastic overcoating comprises an aqueous polymeric dispersion.

12. The extruded tape of claim 9 further comprising at least one of a wetting agent, and an adhesion promoter.

13. The extruded tape of claim 9 wherein said thermoplastic-overcoating is derived from an aqueous dispersion.

14. The extruded tape of claim 9 wherein said thermoplastic overcoating further comprises at least one of antioxidants, ultraviolet (UV) stabilizers, plasticizers, or fillers.

15. The extruded tape of claim 9 wherein said thermoplastic overcoating further comprises a cross-linker.

16. The extruded tape of claim 9 wherein said thermoplastic overcoating further comprises a fiber sizing composition components.

17. The extruded tape of claim 9 wherein the thermoplastic based coating further comprises a fiber sizing composition components.

18. A process of producing the coated tow of claim 1, the process comprising:
feeding one or more spools of continuous fiber tow under tension control to provide stability and prevent transverse movement of the fiber tow;
sinking the continuous fiber tow in a chemical bath that holds the thermoplastic-based coating to wet the continuous fiber tow;
passing the wetted continuous fiber tow through one or more squeezing rollers to remove excessive coating and to shape the cross sectional shape of the continuous fiber tow; and
passing the continuous fiber tow through an oven to dry and fix the coating to the continuous fiber tow.

19. The process of claim 18 further comprising twisting the continuous fiber tow.

20. An oil and gas exploration pipe comprising:
a steel tube or a composite tube; and
an extruded tape of claim 9 spiral wound therearound.
